(19) United States
(12) Patent Application Publication
(10) Pub. No.: US 2022/0241619 A1
(43) Pub. Date: Aug. 4, 2022

(54) HOOD ASSEMBLY FOR AN EMERGENCY BREATHING SYSTEM

(71) Applicant: 3M INNOVATIVE PROPERTIES COMPANY, St. Paul, MN (US)

(72) Inventors: Robert Kyle Fullerton, Matthews, NC (US); Silvia Geciova-Borovova Guttmann, St. Paul, MN (US); Robert D. Williams, Monroe, NC (US); Scott M. Purrington, Grant, MN (US); Jhansi R. Arikatla, Waxhaw, NC (US)

(21) Appl. No.: 17/610,222

(22) PCT Filed: Apr. 30, 2020
(86) PCT No.: PCT/IB2020/054111

§ 371 Date: Nov. 10, 2021

Related U.S. Application Data
(60) Provisional application No. 62/846,312, filed on May 10, 2019.

(51) Int. Cl. A62B 7/02; A62B 17/04; A62B 9/00; A62B 17/00

(52) U.S. Cl. CPC A62B 7/02; A62B 17/001; A62B 9/00; A62B 17/04

(57) ABSTRACT

A breathing system hood assembly that fits over a user's head includes an air impermeable hood having an opening dimensioned to fit over the user's head and an elastically deformable neck seal arranged along at least a portion of the opening. The neck seal includes a region wherein the neck seal is arranged in overlapping relation with itself, whereby the neck seal can expand to fit over a user's head and contract to create a seal with the user's neck.

### BACKGROUND

The present invention relates generally to emergency breathing devices and, more particularly, to a hood assembly for an emergency breathing device.

Emergency Escape Breathing Devices (EEBD) are personal emergency breathing systems used to escape hazardous or toxic environments. Such devices are designed to provide breathable air for a period of time sufficient to allow an individual to evacuate the hazardous environment and reach a safe location where the air is safe to breathe. An EEBD typically includes several primary components including a supply of breathable air, at least one pressure regulator, a hose, and a hood that can be arranged over a wearer's head.

### SUMMARY

There continues to be a need to improve the performance and use of emergency breathing systems. In particular, there is an ongoing desire to have hood assemblies for emergency breathing systems that are comfortable, accommodate a wide range of head and neck sizes, and can be quickly and easily donned (e.g. in one step). The present disclosure generally provides an emergency breathing system, such as an Emergency Escape Breathing Devices (EEBD) that includes, for example, a supply of breathable air, a pressure regulator and a hood assembly.

In one embodiment, the present invention provides a breathing system hood assembly that fits over a user's head wherein the hood assembly includes an air impermeable hood having an opening dimensioned to fit over the user's head, and further includes an elastically deformable neck seal arranged along at least a portion of the opening, wherein the neck seal includes a region wherein the neck seal is arranged in overlapping relation with itself, thereby defining an overlapping region, whereby the neck seal can be stretched or expanded to fit over a user's head, and the neck seal can also contract to create a seal with the user's neck.

In various embodiments and aspects, the neck seal may have a unitary or one-piece construction, the neck seal may have at least a two-piece construction, the overlapping region may be affixed to itself by at least one of stitching, adhesive, a weld (e.g. ultrasonic weld), or a mechanical fastener, the neck seal may be folded onto itself thereby forming first and second portions arranged in partially overlapping relation, the neck seal may be twisted onto itself in overlapping relation thereby forming first and second portions arranged in partially overlapping relation, the first and second portions may be arranged to form an acute angle, the first and second portions may be arranged to form an obtuse angle, the first and second portions may be arranged to form an angle that faces away from the air impermeable hood of at least about 80 degrees and no greater than about 110 degrees, the neck seal may comprise at least a pair of elastic bands, the elastic bands may be formed of the same or different materials, the neck seal may comprise an elastic band formed of a thin broad strip of material, the elastic band may have a width of at least about 0.25 inches and a width of no greater than about 3.5 inches, the elastic band may have a contracted half-length of no greater than about 4 inches, the elastic band may be reversibly expandable to a half-length of at least about 11 inches, the force required to elongate a 1.5 inch wide elastic band 3.5 inches may be no greater than about 10 Newtons, the elastic band may have an elongation of at least about 50 percent and no greater than about 200 percent, a neck seal having an overlapping region may have an elongation that is at least about 0.5 inches greater than a neck seal without an overlapping region, a neck seal having an overlapping region may have an elongation that is at least about 5 percent greater than a neck seal without an overlapping region, the neck seal may comprise a fabric material, the fabric material may comprise a woven fabric, the fabric may include at least one of polyester, latex elastomer, rubber, nylon, polyamide, cotton, and combinations thereof, the air impermeable hood may comprise a transparent synthetic plastic material, the hood assembly may be incorporated into a Self-Contained Breathing Apparatus (SCBA), a Powered Air Purifying Respirator (PAPR), an Emergency Escape Breathing Device (EEBD), or an Air-Purifying Respirator (APR), the hood assembly may comprise a port connectable to a breathable air supply, the breathable air may be supplied by a cylinder of compressed air, the breathable air may be filtered air, the breathable air supply may be a chemical oxygen generator, the neck seal may automatically contract to form a seal around the user's neck once it is pulled over the user's head and released by the user thereby allowing the hood assembly to be donned by the user in a single step, and/or the neck seal may be attached to the hood along the entire perimeter of the opening (e.g. in one-step).

Advantages of certain embodiments of the emergency breathing system described herein include providing a hood assembly that is easy to make and use, affordable, comfortable, accommodates a wide variety of head and neck sizes, and is easily donned.

### BRIEF DESCRIPTION OF THE DRAWINGS

FIG. 1 is a perspective view of an emergency breathing system including a hood assembly according to an embodiment of the invention.

FIG. 2 is a diagrammatic illustration of a user wearing the emergency breathing system shown in FIG. 1.

FIG. 3 is a plan view of a hood assembly according to a first embodiment of the invention.

FIG. 4 is a plan view of a hood assembly according to a second embodiment of the invention.

FIG. 5 is a detailed plan view of a first elastic neck seal in an intermediate or pre-assembled state prior to being combined with a hood.

FIG. 6 is a detailed plan view of a second elastic neck seal in an intermediate or pre-assembled state prior to being combined with a hood.

FIG. 7 is a plan view of the elastic neck seal of Example A having a 60-degree overlap.

FIG. 8 is a plan view of the elastic neck seal of Example B having a 90-degree overlap.

FIG. 9 is a plan view of the elastic neck seal of Example A having a 120-degree overlap.

FIG. 10 is a plan view of an elastic neck seal of Example A-T having an approximately 60-degree angle twist.

FIG. 11 is a plan view of an elastic neck seal of Example B-T having an approximately 90-degree angle twist.

FIG. 12 is a plan view of an elastic neck seal of Example C-T having an approximately 120-degree angle twist.

FIG. 13 is a plan view of an elastic neck seal of Example CS with no overlap or twist angle.

FIG. 14 is a graph of Max Force versus Overlap Angle for different elastic bands made using different methods of manufacture and raw materials.

FIG. 15 is a graph of Performance Increase (in percent) versus Overlap Angle (in degrees) for different elastic bands made using different methods of manufacture and raw materials.

FIG. 16 is a graph of Max force versus Overlap Angle for four different overlap and twist angles.

FIG. 17 is a graph of Performance Increase (in percent) versus Overlap Angle (in degrees) for three different overlap and twist angles.

### DETAILED DESCRIPTION

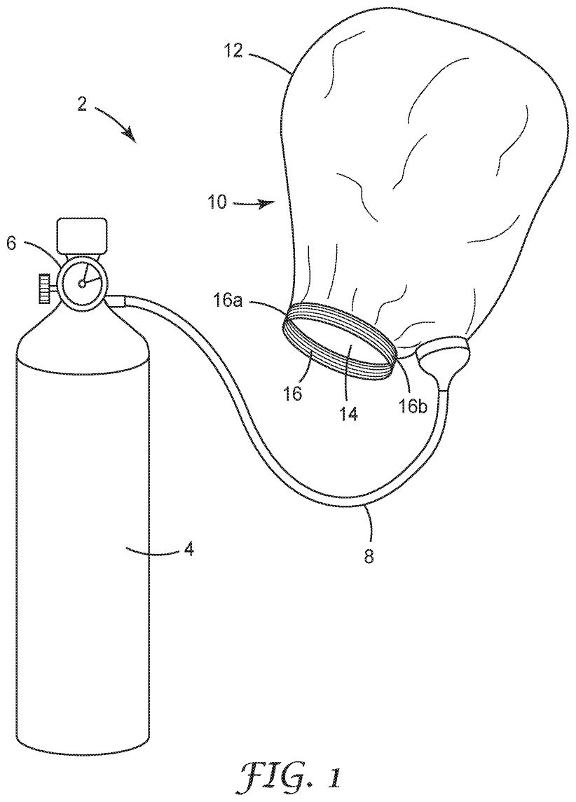

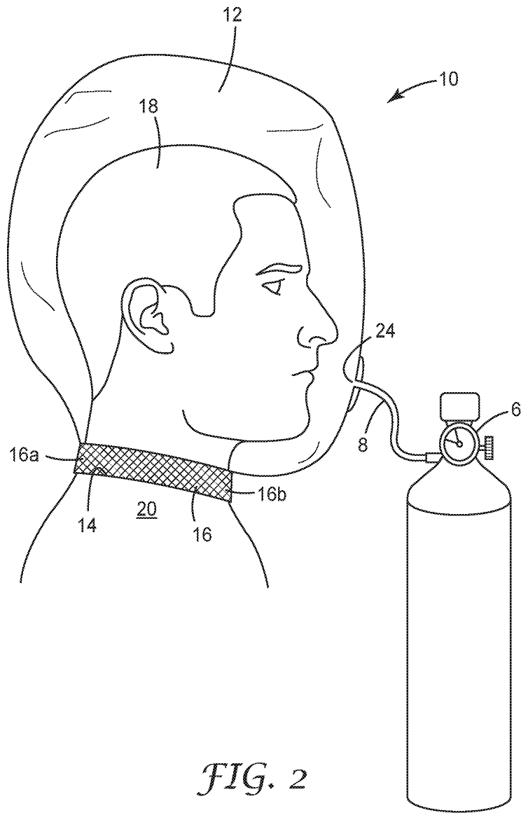

Referring now to FIGS. 1 and 2, wherein like reference numerals refer to like or corresponding parts, there is shown an emergency breathing system or emergency escape breathing device (EEBD) 2 including a tank or cylinder 4 of compressed breathable air, a regulator 6, and a flexible hose or tube 8 for delivering breathable air from the cylinder 4 to a hood assembly 10. The hood assembly 10 includes a hood 12 having an opening 14 with an elastically deformable neck seal 16 that is expandable to allow the hood 12 to be placed over a user's head 18 and is contractible to allow the neck seal 16 to be secured around the user's neck 20. Other aspects of an emergency breathing system are described in U.K. Patent Application No. GB2191950A (Application No. 8615744—Glynn et al), the entire contents of which are hereby incorporated by reference.

The opening 14 in the hood 12 and the opening formed by the neck seal 16 are dimensioned to accommodate (i.e. fit over) the head 18 of a user. In addition, the neck seal 16 is configured to form a seal around the user's neck 20 to prevent, or at least significantly reduce, the likelihood of having hazardous or harmful gases or particulate matter entering the protective space created around the user's head by the hood 12.

In one aspect, the opening 14 and neck seal 16 are dimensioned to accommodate a head having a perimeter of at least about 17 inches, a perimeter of at least about 18 inches, a perimeter of at least about 19 inches, or a perimeter at least about 20 inches. In another aspect, the opening 14 and the neck seal 16 are dimensioned to accommodate a head having a perimeter of no greater than about 25 inches, no greater than about 26 inches, not greater than about 27 inches, or no greater than about 28 inches. In another aspect, the neck seal 16 is dimensioned to accommodate a neck having a perimeter of at least about 9 inches, a perimeter of at least about 10 inches, at least about 11 inches, or a perimeter of at least about 12 inches, and a neck having a perimeter of no greater than about 20 inches, a perimeter of no greater than about 21 inches, a perimeter of no greater than about 22 inches, or a perimeter of no greater than about 23 inches.

In the illustrated embodiment, the neck seal 16 includes a pair of overlapping regions 16a, 16b in which the neck seal 16 is arranged in overlapping relation with itself. While the illustrated embodiment includes two overlapping regions—one each at opposite ends of the neck seal 16—it will be recognized that the neck seal 16 may include only one overlapping region or it may include three or more overlapping regions. In addition, in the illustrated embodiment, the elastic neck seal 16 is provided along the entire perimeter of the opening 14. However, it will be recognized that the neck seal 16 may be provided along a portion of the opening 14.

In accordance with one aspect of the invention, the overlapping regions 16a, 16b were found to improve the ability of the neck seal 16 to accommodate a wider range of head and neck sizes (i.e. both large and small heads and necks). More specifically, the overlapping regions 16a, 16b improve the neck seal's ability to expand and, therefore, fit over a user's head and also improve the neck seal's ability to contract and create a seal around the user's neck. That is, providing the neck seal 16 with at least one overlapping region increases the extensibility of the neck seal 16, thereby allowing the neck seal 16 to accommodate a wider range of head sizes, while also allowing the neck seal 16 to be comfortably secured around the user's neck in a manner that creates a suitable seal to protect the user from hazardous or toxic gases that may be present in the surrounding environment. In addition, the neck seal 16 automatically forms a seal around the user's neck once it is pulled over the user's head, whereby the hood assembly 10 can be donned by a user in a single step.

As described in more detail below, the neck seal 16 may have a unitary (i.e. one-piece) construction in which at least one overlapping region 16a, 16b is formed by folding or twisting the neck seal 16 over onto itself in overlapping relation, or the neck seal 16 may have an at least a two-piece construction (i.e. a multiple piece construction) in which the overlapping region is formed by arranging at least two separate or discrete strips of material in overlapping relation which are secured or affixed to each other. The particular manner in which the strips are secured to each other is not critical to the invention so long as it provides the desired function. Suitable means for affixing the separate strips to each other include, for example, stitching, adhesive, welds or mechanical fasteners (e.g. buckle, clip, clamps, button, snap). Furthermore, the overlapping regions 16a, 16b may be formed such that portions of the neck seal 16 that extend outwardly in opposite directions from the overlapping regions may be arranged at selected angles.

In the illustrated embodiment, the hood assembly 10 includes a hood 12 containing a large opening 14 at the bottom of the hood 12 sized to accommodate the head 18 and neck 20 of the end user, and further contains a small opening 24, or air connection port, in the front of the hood 12 that is connectable with a breathable air supply. In the illustrated embodiment, breathable air is supplied by the cylinder 4 of compressed air that is connected with the hood 12 via hose 8. In other embodiments, breathable air may include filtered air, or the breathable air supply may include a chemical oxygen generator.

In the illustrated embodiment, the hood 12 is formed of an air-impermeable material such as a transparent synthetic plastic material. A suitable material includes, for example, polyurethane. Alternatively, it will be recognized that the hood 12 may be formed from air-impermeable materials that are not transparent (e.g. woven or non-woven cloth or fabric materials), and the hood 12 may be provided with a generally transparent window through which the user can view the surrounding area.

The elastically deformable (i.e. reversibly stretchable and contractible) neck seal 16 is provided along the opening 14. In the illustrated embodiment, the overlapping regions 16a, 16b of the neck seal 16 are provided generally along the front and the back of the hood 12. That is, the overlapping regions 16a, 16b are arranged approximately 180 degrees from each other at opposite ends of the neck seal 16. It will be recognized that the overlapping regions 16a, 16b may be provided at different orientations relative to each other (e.g. 90 degrees from each other) as well as at different locations relative to the hood 12 (e.g. along the sides of the hood 12 rather than along the front and back of the hood).

In one embodiment, the neck seal 16 comprises a fabric material. The fabric material may comprise, for example, a knit or woven (e.g. twill) material. Suitable materials for the neck seal 16 include, for example, polyester, latex elastomer, rubber and combinations thereof. In a specific embodiment, the neck seal 16 comprises at least one of neoprene and spandex (e.g. Lycra).

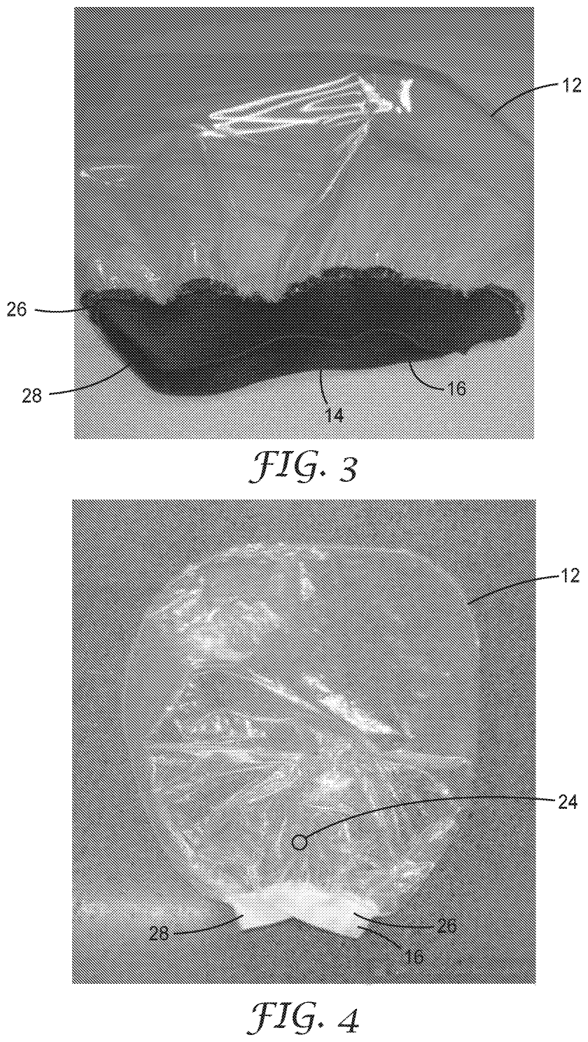

Referring to FIGS. 3 and 4, FIG. 3 shows a side view of the hood assembly 10 depicted in FIGS. 1 and 2, and FIG. 4 shows a front view of the hood assembly 10 depicted in FIGS. 1 and 2. It will be recognized that referring to FIG. 3 as a side view and FIG. 4 as a front view is somewhat arbitrary. FIG. 3 is referred to as the side view because this is generally how the hood assembly 10 would appear if the hood assembly 10 were worn by a user as intended and viewed from the side of the user (i.e. looking from the shoulder of the user toward the ear of the user). Similarly, FIG. 4 is referred to as the front view because this is generally how the hood assembly 10 would appear when viewed from in front of the user (i.e. looking at the face of the user).

In the embodiment depicted in FIGS. 3 and 4, the neck seal 16 comprises a pair of elastic bands 26, 28 formed of a thin broad strip of material. In the illustrated embodiment, each elastic band 26, 28 is formed of the same material. It will be recognized, however, that the bands 26, 28, or portions of each band, may be formed of different materials.

In a specific aspect, the neck seal 16 has a width of at least about 0.25 inches, at least about 0.5 inches, or at least about 1 inch. In another aspect, the neck seal 16 has a width of no greater than about 2 inches, no greater than about 2.5 inches, or no greater than about 3.5 inches.

As alluded to previously, the neck seal 16 is configured to accommodate a wide range of head and neck sizes. In order to do so, in certain embodiments, the neck seal 16 has a natural resting (i.e. contracted or unexpanded) half-length of no greater than about 4 inches, no greater than about 6 inches, no greater than about 8 inches, no greater than about 9 inches, or no greater than about 10 inches. In addition, the neck seal 16 is capable of being elastically deformed (i.e. it can be stretched without breaking) to a half-length of at least about 11 inches, at least about 12, or at least about 13 inches. The half-length of the neck seal 16 refers its length when it is flattened such that the opposing sides are allowed to contact each other.

In embodiments where the neck seal 16 comprises a pair of elastic bands, each elastic band 26, 28 has a natural resting (i.e. contracted or unexpanded) length of no greater than about 4 inches, no greater than about 6 inches, no greater than about 8 inches, no greater than about 9 inches, or no greater than about 10 inches. In addition, the neck seal 16 is capable of being elastically deformed (i.e. stretched without breaking and return to its approximate original length) to a length of at least about 11 inches, at least about 12, or at least about 13 inches.

Another way of characterizing the extended, or stretched, size of the neck seal 16 is by its degree of elongation. Accordingly, in one aspect, the neck seal 16 is capable of being elongated by at least about 50 percent, at least about 60 percent, or at least about 75 percent, and is capable of being elongated by no greater than about 125 percent, no greater than about 150 percent, or no greater than about 200 percent. That is, by way of example, a neck seal 16 having a half-length of 7 inches can be stretched to a half-length of at least about 10.5 inches (i.e. 50 percent) to no greater than about 21 inches (i.e. 200 percent, which means the neck seal can be stretched to triple its original or unstretched length). Similarly, in embodiments where the neck seal 16 comprises a pair of elastic bands 26, 28, each elastic band is being capable of being elongated by at least about 50 percent, at least about 60 percent, or at least about 75 percent, and is capable of being elongated by no greater than about 100 percent, no greater than about 150 percent or no greater than about 200 percent.

In another characterizing aspect, the force required to elongate a 1.5 inch wide elastic band used to form the neck seal 16 by 3.5 inches is no greater than about 10 Newtons, no greater than about 20 Newtons, or no greater than about 30 Newtons. This range of stretch force is desirable because it allows the neck seal 16 to be readily stretched to fit over the head of the user and also allows the neck seal 16 to form a comfortable seal with the user's neck (i.e. creates an adequate seal without being too tight).

In a further characterizing aspect, a neck seal 16 having at least one overlapping region 16a, 16b has an elongation that is at least about 5 percent greater, at least about 10 percent greater, at least about 15 percent greater, or at least about 20 percent greater than a neck seal without an overlapping region. In a specific embodiment, a neck seal 16 having a half-length of about 7 inches having at least one overlapping region 16a, 16b will have an elongation that is at least about 0.5 inches greater, at least about 1 inch greater, or at least about 1.5 inches greater than a neck seal that does not include an overlapping region. In this manner, the overlapping region provides the neck seal 16 with additional elongation properties that enhance the neck seal's ability to accommodate a wider range of head and neck sizes.

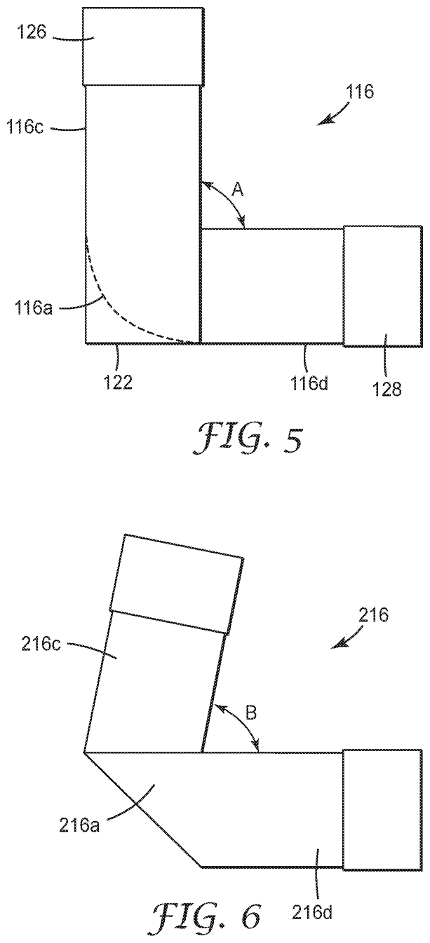

Referring now to FIG. 5, wherein similar or like features to those illustrated in FIGS. 1 and 2 are incremented by 100, there is shown one embodiment of a neck seal 116 in a pre-assembled condition. That is, for ease of illustration, the neck seal 116 is shown unattached to a hood, and the free ends of the neck seal 116 are not fastened together to form an endless or continuous loop or band. In the illustrated embodiment, the neck seal 116 comprises two separate strips of material arranged in overlapping relation, thereby forming an overlapping region 116a. More specifically, the neck seal 116 includes a pair of legs portions 116c, 116d arranged in overlapping relation and stitched together along line 122. In the illustrated embodiment, the stitching line 122 is depicted as being curved, but it will be recognized that the stitching line 122 may also be linear.

As alluded to above, the neck seal 116 can be configured to have an overlapping region that creates a desired angle. In the illustrated embodiment, leg portions 116c, 116d are arranged to create an angle “A” of approximately 90 degrees. In other embodiments, the leg portions 116c, 116d may be arranged to form an acute angle or an obtuse angle. In a specific embodiment, the leg portions 116c, 116d are arranged to form an angle that faces away from the air impermeable hood 12 that ranges from at least about 80 degrees to no greater than about 110 degrees.

Referring now to FIG. 6, wherein similar or like features to those illustrated in FIGS. 1 and 2 are incremented by 200, there is shown another embodiment of a neck seal 216 in a pre-assembled condition. In the embodiment illustrated in FIG. 6, the neck seal 216 comprises a single strip of material that is folded or otherwise arranged in at least partially overlapping relation to form the overlapping region 216a. Arranged in this manner, the strip includes first and second portions 216c, 216d that are arranged in partially overlapping relation, thereby creating the overlapping region 216a. In this embodiment, it will be recognized that the neck seal 216 may, but need not, be secured to itself in the overlapping region 216a.

In another embodiment, rather than being folded over onto itself along a clean fold line, the neck seal 216 may be twisted and, thereby, arranged onto itself in overlapping relation.

As with the embodiment illustrated in FIG. 5, the neck seal 216 illustrated in FIG. 6 may be configured to have an overlapping region that creates a desired angle. In the embodiment illustrated in FIG. 6, the first and second portions 216c, 216d are arranged to create an angle “B” that is less than 90 degrees. In other embodiments, the first and second portions 216c, 216d may be arranged to form an angle of approximately 90 degrees or an obtuse angle. As with the embodiment illustrated in FIG. 5, the first and second portions 216c, 216d may be arranged to form an angle that faces away from the air impermeable hood 12 that ranges from at least about 80 degrees to no greater than about 110 degrees.

Persons of ordinary skill in the art may appreciate that various changes and modifications may be made to the invention described above without deviating from the inventive concept. For example, the personal emergency breathing system has been described mainly in the context of an Emergency Escape Breathing Device (EEBD). However, it will be recognized that the personal emergency breathing system may be incorporated into, for example, a Self-Contained Breathing Apparatus (SCBA), a Powered Air Purifying Respirator (PAPR), or an Air-Purifying Respirator (APR). That is, it will be recognized that the hood assembly described herein may be incorporated into any breathing system that would benefit from such a hood assembly. Thus, the scope of the present invention should not be limited to the structures described in this application, but only by the structures described by the language of the claims and the equivalents of those structures.

### Test Methods

Test method for Measuring Elongation

Elongation was measured on Instron Model number 5565, Serial number C2067, from Instron, Norwood, Mass. following ASTM D5034. Results, measured as force in Newtons at a specified elongation. During the test it was used 100 N load cell, 3.5″ gage length, 1″ narrow jaws.

### Methods for Preparing Samples

NIOSH has specifications for maximum and minimum circumference for head and neck dimensions to make sure that all head and neck sizes are accommodated for easy donning and creating an adequate seal around the neck. According to the present disclosure, the described design has a one-step donning procedure, and accommodates the largest head circumference to don and smallest neck circumference to create an adequate seal around the neck. The seal around the neck is believed to be the most important dimension to have product work properly. As described below, the inner edge of the elastic was used, for overlapped or twist design, as comparison distance to elastic without overlap or twist which creates the seal in final constructed designs.

The overlapped angles described in the Examples below were made by stacking and overlapping two separate end pieces of elastic on the top of each other or twisting one continuous piece to the preferred angle. The final closure construction was designed with a minimum of one overlapped angle made by one of the methods stated above or their combinations. All testing samples use 3M™ Gripping Material GM631 applied to the sample ends to guide during the testing alignment of the sample with jaw edge to have consistent distance and to prevent slippage during the tensile test on Instron.

### Example A

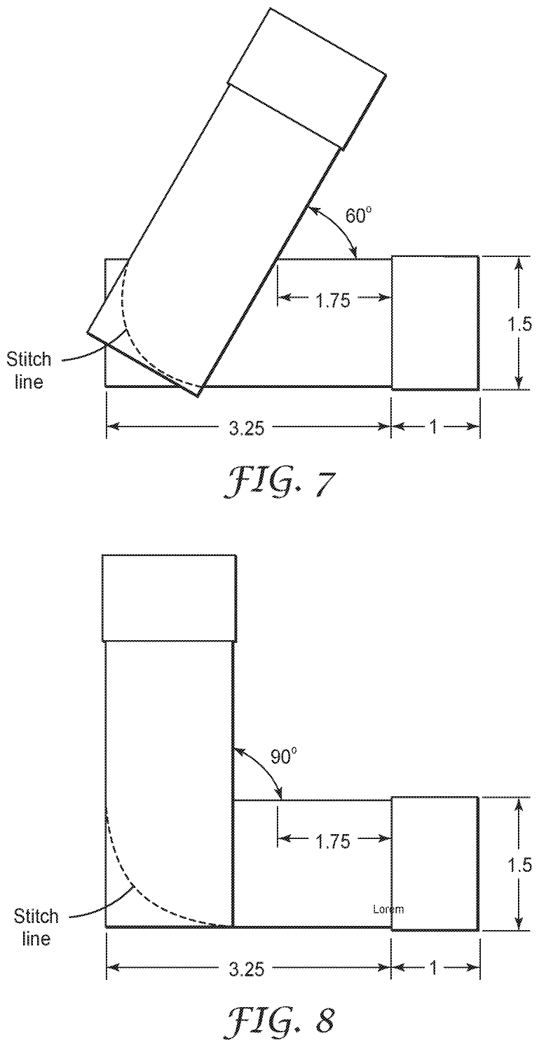

Example A describes a sample with 60-degree angle overlap, FIG. 7, produced by manually cutting and sewing two separate elastic pieces together. The overlapped sample was made from 1.5 inch wide elastic, Table 2. Two elastic pieces were manually cut to 4.75 inch length, Table 1. Two ends of two pieces were stacked on top of each other, right piece on the top of left end, with their inner edge producing a in 60-degree angle. After overlapping the two pieces the outer edges of the elastic pieces were connected with a curved stitch line of defined radius, Table 1, to create continuous outer edge. The stitch line was made with white thread commercially available under the trade designation “D-Core 31001” (Cotton wrap Polyester, 40 Tex) from American & Effird LLC, Mt Holly, N.C. Sewing was done using a single needle lock stitch machine with automatic under trimmer commercially available under the trade designation “Mitsubishi LS2-1780” from Mitsubishi Electric Corporation, Tokyo, Japan. After sewing two pieces together the inner edge was measured and marked from the overlap point to 1.75 inch, Table 1, and applied “3M™ Gripping Material GM631” from 3M Company, St. Paul, Minn.

Overlapped angle samples were tested according to Test Method for Measuring tensile strength as described above with values for Max. load (N) and variation from control sample are given in Table 3. Example 1A corresponds to FIG. 7.

### Example B

Example B was prepared as in example A with 90-degree angle overlap, FIG. 8, followed by sewing, application of gripping material and testing as in example A.

### Example C

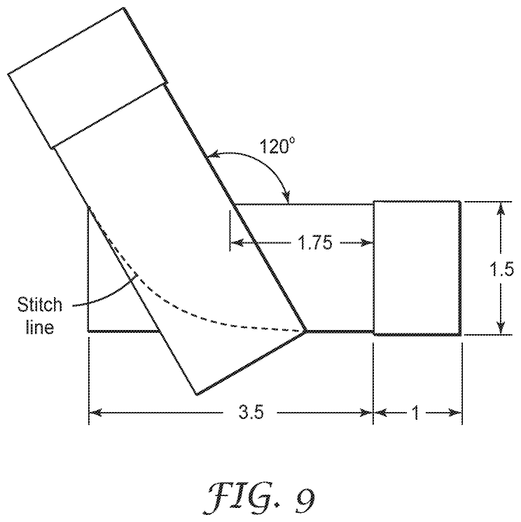

Example C was prepared as in example A with 120-degree angle overlap, FIG. 9, followed by sewing, application of gripping material and testing as in Example A.

### Example A-T

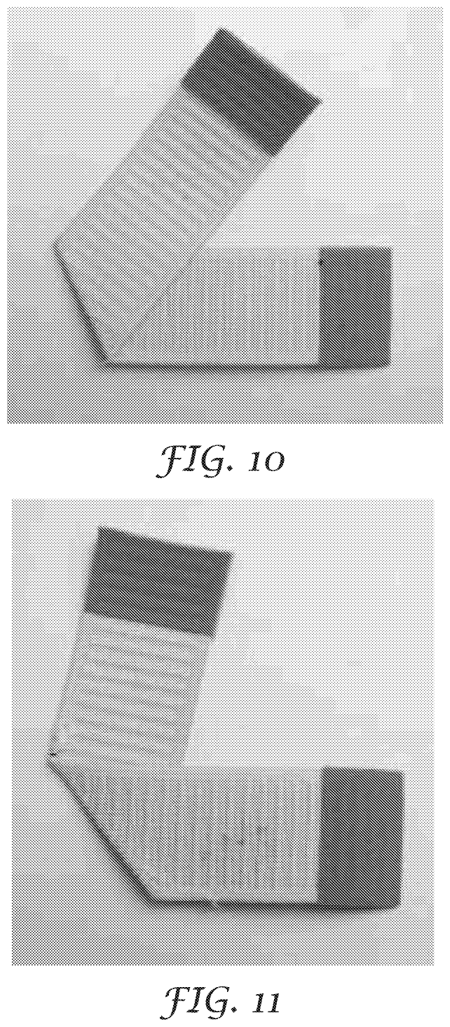

Example A-T describes a sample with 60-degree angle twist, FIG. 10, produced by manually cutting one elastic piece and topstitched together. The twisted sample was made from 1.5 inch wide elastic, Table TT. The elastic piece was manually cut in 8.25 inch length, Table 1. Two ends of one-piece elastic were twisted, right side on the top of left side, with their inner edge in 60-degree angle followed by sewing, application of gripping material and testing as in Example A.

### Example B-T

Example B-T was prepared as in example A-T with 90-degree angle twist, FIG. 11, followed by sewing, application of gripping material and testing as in example A.

### Example C-T

Example C-T was prepared as in example A-T with 120-degree angle twist, FIG. 12, followed by sewing, application of gripping material and testing as in example A.

### Example CS

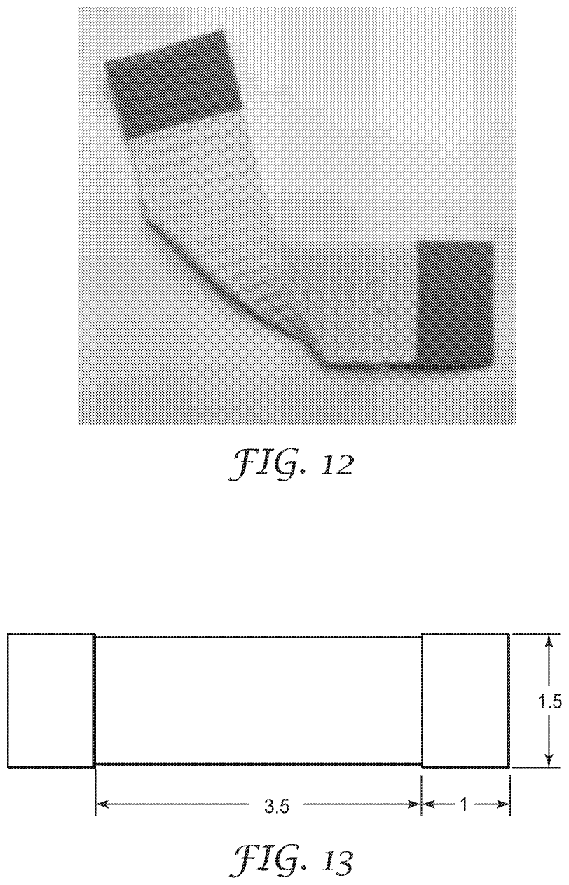

Example CS (Comparative Sample) describes a sample without overlap or twist with angle reference Zero, FIG. 13, produced by manually cut 1 elastic piece followed by application of gripping material and testing as in Example A

TABLE 1
SAMPLE DIMENSIONS

| Example | A | B | C | A-T | B-T | C-T | CS |
|---|---|---|---|---|---|---|---|
| Overlap angle [°] | 60 | 90 | 120 | 60 | 90 | 120 | 0 |
| Cut length [inch] | 4.75 | 4.25 | 4.5 | 8.25 | 7 | 6.38 | 5.5 |
| Mark distance per | 1.75 | 1.75 | 1.75 | 2.75 | 2.75 | 2.75 | 3.5 |
| piece [inch] | | | | | | | |
| Stitch distance | 1.92 | 2.31 | 3.04 | 1.5 | 1.81 | 2.79 | N/A |
| [inch] | | | | | | | |
| Stitch radius [°] | 1.07 | 1.57 | 3.28 | N/A | N/A | N/A | N/A |

TABLE 2
MATERIAL CONTENT AND MANUFACTURER
INFORMATION

| | Example | | |
|---|---|---|---|
| | 1 | 2 | 3 |
| Sample ref. | Knit Elastic | Twill Woven Elastic | Woven Elastic |
| Material | Polyester yam, | 82% polyester and | 65% polyester |
| | Latex elastomer, | 18% rubber | and |
| | stretch 110%, | Double-side | 35% rubber |
| | approximate | Twill Woven | |
| | thickness 0.045 | Elastic, Black | |
| | inch, | 32110, Thickness: | |
| | CM-217 | approx. 0.08 | |
| | | inch/2 mm | |
| Manufac- | Lea & Sachs, Inc, | iCraft | Prym Consumer |
| turer | Des Plains, IL | | USA Inc., |
| | | | Spartanburg, |
| | | | South |
| | | | Carolina |

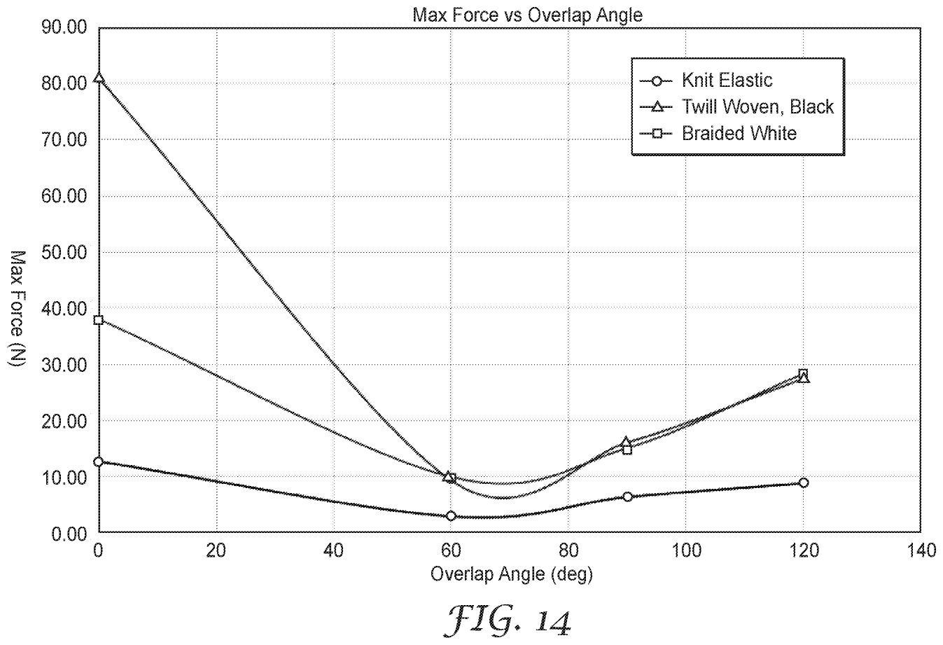

FIG. 14 is a graph representing a range of elastic bands made with different methods of manufacturing and raw materials, Table 2, at constant width and length. In the graph, trend of max. force needed to elongate Examples at constant distance shows improvement in force reduction with any overlapped angle designs (60, 90, 120-degree angles) compared to Comparative flat sample of the same elastic band (none-180 degree angle), Table 3. Furthermore, with acute overlapped angle there a force reduction compared to obtuse overlapped angles. This reduction and force required is not the same for all types of elastic materials. The reduction of force comes from an overlap or twist in the elastic band regardless of the material or method of manufacturing the elastic band.

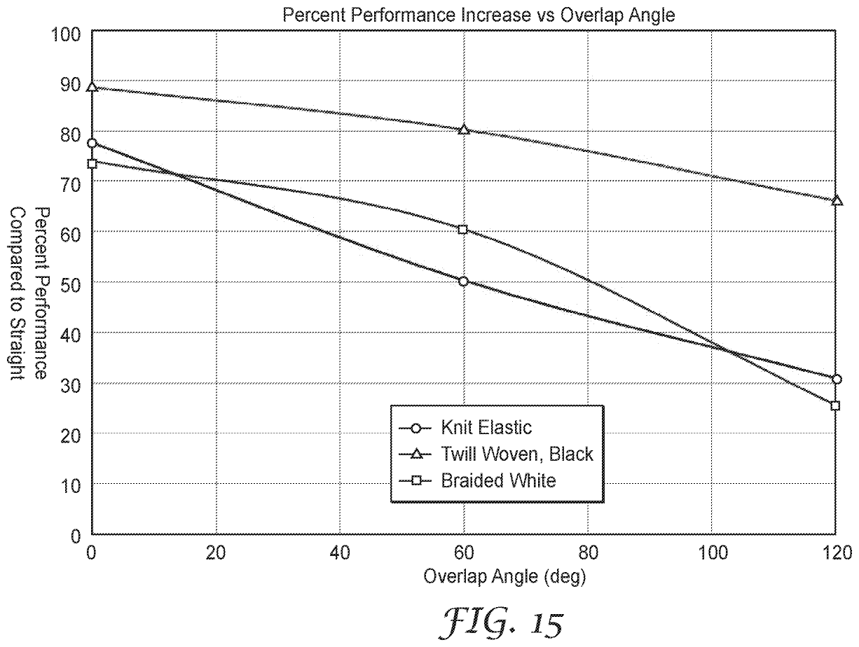

FIG. 15 is a graph representing different methods of making, including overlapped or twisted, compared to Comparative flat sample, Table 4. Examples show improvement in force reduction regardless on method of making compared to Comparative samples that do not include a twist or overlap. In addition, the overlap method of making samples shows improvement in force reduction in certain range of angles compared to twist method of making.

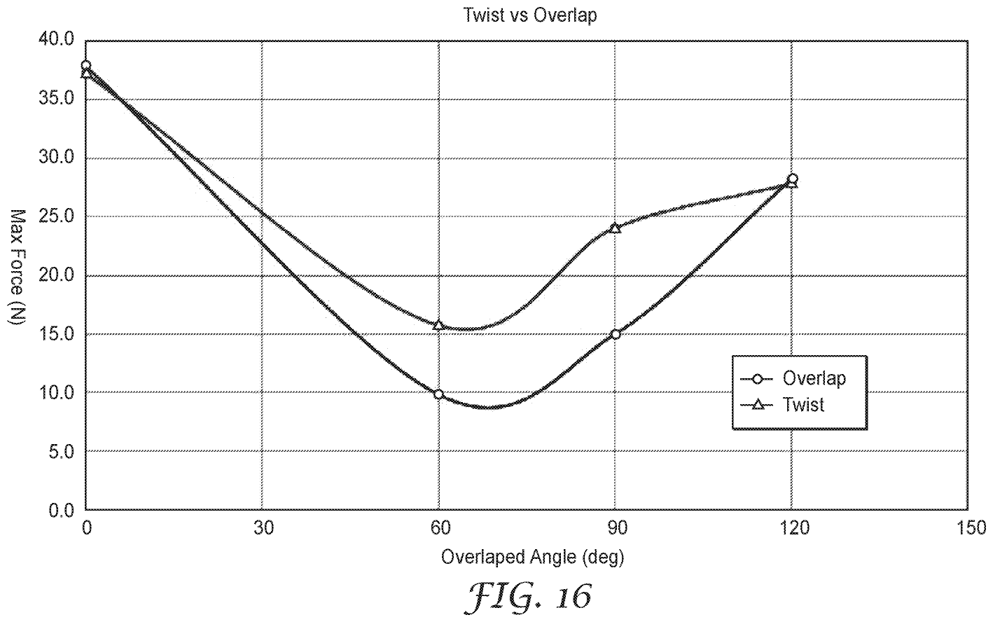

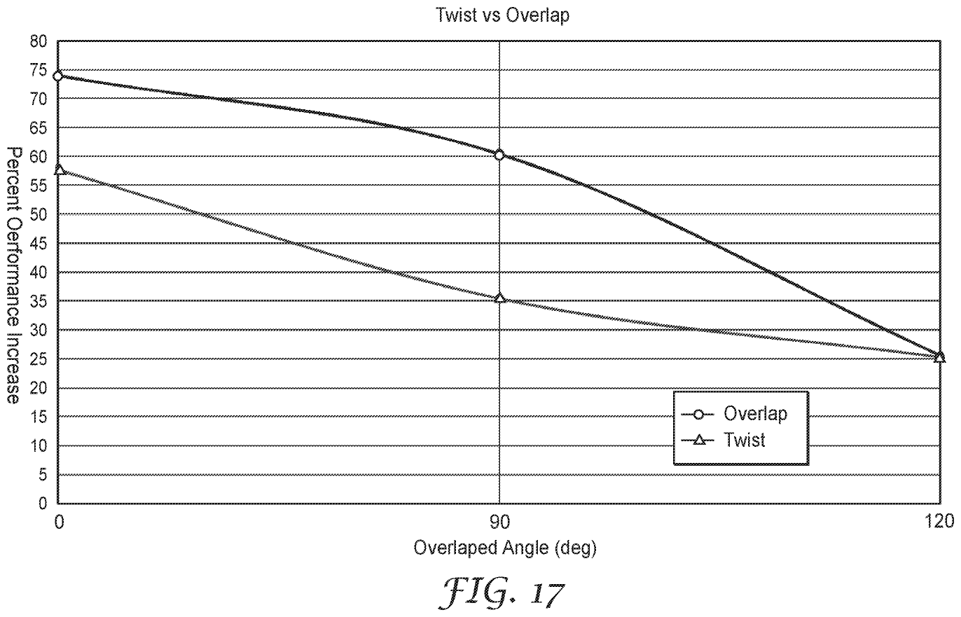

The test results indicate that the inner and outer edge distance of the elastic design, angle of the overlap, and elastic raw materials and method of manufacturing, Tables 1 and 2, are parameters that influence the overall design performance. Based on the results, a preferred method of making is by creating overlap with two pieces of elastic made by knitting manufacturing method, see FIG. 15-19. In one embodiment, a knit elastic having a width of 1.5 inch and an overlap angle ranging from 90-120 degrees was used.

TABLE 3

| | | | | Increased |
|---|---|---|---|---|
| | | | | Performance |
| | | | | compare to 0 |
| | | | | degree angle |
| Example | Sample ref. | Angle [°] | Max. Load [N] | [%] |
| 1A | Knit Elastic | 60 | 2.85 | 78 |
| 1B | Knit Elastic | 90 | 6.32 | 50 |
| 1C | Knit Elastic | 120 | 8.78 | 31 |
| CS1 | Knit Elastic | 0 | 12.71 | — |
| 2A | Twill Woven | 60 | 9.22 | 89 |
| | Elastic | | | |
| 2B | Twill Woven | 90 | 15.98 | 80 |
| | Elastic | | | |
| 2C | Twill Woven | 120 | 27.34 | 66 |
| | Elastic | | | |
| CS2 | Twill Woven | 0 | 80.8 | — |
| | Elastic | | | |
| 3A | Woven Elastic | 60 | 9.86 | 74 |
| 3B | Woven Elastic | 90 | 14.99 | 60 |
| 3C | Woven Elastic | 120 | 28.20 | 26 |
| CS3 | Woven Elastic | 0 | 37.88 | — |

Comparison of max force to elongate differently made elastics with constant width of 1.5 inch and elongation distance 3.5″ within straight elastic 3 different overlapped angles.

FIG. 15 shows the results for elongation test comparing Increased performance in % versus overlapped angle of different elastics

TABLE 4

| | | | | | Increased |
|---|---|---|---|---|---|
| | | | | | Performance |
| | | | | | compare to 0 |
| | | Method of | | Max. Load | degree angle |
| Example | Sample | making | Angle | (N) | [%] |
| 3A | Woven | Overlap | 60 | 9.86 | 74 |
| | Elastic | | | | |
| 3B | Woven | Overlap | 90 | 14.99 | 60 |
| | Elastic | | | | |
| 3C | Woven | Overlap | 120 | 28.20 | 26 |
| | Elastic | | | | |
| 3A - T | Woven | Twist | 60 | 15.74 | 58 |
| | Elastic | | | | |
| 3B - T | Woven | Twist | 90 | 24.04 | 35 |
| | Elastic | | | | |
| 3C - T | Woven | Twist | 120 | 27.82 | 25 |
| | Elastic | | | | |
| CS3 | Woven | None | 0 | 37.88 | — |
| | Elastic | | | | |

Comparison of Max. Force to elongate elastic made by Overlapping and Twisting within straight elastic and 3 angles.

1. A breathing system hood assembly that fits over a user's head, comprising:
an air impermeable hood having an opening dimensioned to fit over the user's head; and
an elastically deformable neck seal arranged along at least a portion of the opening;
wherein the neck seal includes a region wherein the neck seal is arranged in overlapping relation with itself, whereby the neck seal can expand to fit over a user's head and contract to create a seal with the user's neck.

2. A hood assembly as defined in claim 1, wherein the neck seal has a unitary construction.

3. A hood assembly as defined in claim 1, wherein the neck seal has at least a two-piece construction.

4. A hood assembly as defined in claim 1, wherein the overlapping region is affixed to itself by at least one of stitching, adhesive, a weld, or a mechanical fastener.

5. A hood assembly as defined in claim 1, wherein the neck seal is folded onto itself, thereby forming first and second portions arranged in partially overlapping relation.

6. A hood assembly as defined in claim 1, wherein the neck seal is twisted onto itself in overlapping relation, thereby forming first and second portions arranged in partially overlapping relation.

7. A hood assembly as defined in claim 5, wherein the first and second portions are arranged to form an angle facing away from the air impermeable hood of at least about 80 degrees and no greater than about 110 degrees.

8. A hood assembly as defined in claim 1, wherein the neck seal comprises at least a pair of elastic bands.

9. A hood assembly as defined in claim 1, wherein the neck seal comprises an elastic band formed of a thin broad strip of material.

10. A hood assembly as defined in claim 9, wherein the elastic band has a width of at least about 0.25 inches and a width of no greater than about 3.5 inches.

11. A hood assembly as defined in claim 10, wherein the elastic band has a contracted half-length of no greater than about 4 inches.

12. A hood assembly as defined in claim 11, wherein the elastic band is reversibly expandable to a half-length of at least about 11 inches.

13. A hood assembly as defined in claim 12, wherein the force required to elongate a 1.5 inch wide elastic band 3.5 inches is no greater than about 10 Newtons.

14. A hood assembly as defined in claim 13, wherein the elastic band has an elongation of at least about 50 percent and no greater than about 200 percent.

15. A hood assembly as defined in claim 1, wherein a neck seal having an overlapping region has an elongation that is at least about 5 percent greater than a neck seal without an overlapping region.

16. A hood assembly as defined in claim 1, wherein the neck seal comprises a fabric material.

17. A hood assembly as defined in claim 16, wherein the fabric material comprises a woven fabric.

18. A hood assembly as defined in claim 17, wherein the fabric includes a polymer.

19. The hood assembly of claim 1 incorporated into at least one of a Self-Contained Breathing Apparatus (SCBA), a Powered Air Purifying Respirator (PAPR), an Emergency Escape Breathing Device (EEBD), and an Air-Purifying Respirator (APR).

20. A hood assembly as defined in claim 1, wherein the neck seal is attached to the hood along the entire perimeter of the opening.
